(19) United States
(12) Patent Application Publication
(10) Pub. No.: US 2023/0140242 A1
(43) Pub. Date: May 4, 2023

(54) DATA PROCESSING METHOD AND APPARATUS AND ELECTRONIC DEVICE

(71) Applicant: THE FIRST INSTITUTE OF OCEANOGRAPHY,MNR, QINGDAO (CN)

(72) Inventors: ZHENYA SONG, QINGDAO (CN); YUEJIN YE, NINGDE (CN); SHENGCHANG ZHOU, HEZE (CN); MENGXUAN CHEN, BEIJING (CN); LANNING WANG, BEIJING (CN)

(21) Appl. No.: 17/837,078

(22) Filed: Jun. 10, 2022

(30) Foreign Application Priority Data
Oct. 28, 2021 (CN) 202111258886.6

(51) Int. Cl. G06F 30/20

(52) U.S. Cl. CPC G06F 30/20; G06F 2113/08

(57) ABSTRACT

The present application provides a data processing method and apparatus and an electronic device. The method includes: dividing geographic regions of the earth in a longitudinal direction, a latitudinal direction, and a vertical direction according to a preset spatial resolution, to obtain a three-dimensional grid structure corresponding to the earth space; dividing the grids in the grid structure on grid planes corresponding to the longitudinal direction and the latitudinal direction in the grid structure, to obtain grid sub-structures corresponding to each computing core; dividing grids in the grid sub-structures in a first direction or the vertical direction, to obtain secondary grid sub-structures; allocating regional data corresponding to the secondary grid sub-structures to a primary computing unit; and controlling the primary computing unit to allocate regional data corresponding to smaller secondary grid sub-structures to the at least one computing subunit.

### FIELD OF TECHNOLOGY

The present application relates to the technical field of data processing, and specifically, to a data processing method and apparatus and an electronic device.

### BACKGROUND

Ocean circulation is the study of wind-induced ocean currents and density currents caused by uneven density distribution, generation and distribution of current swirls in oceanic circulation, westward strengthening of ocean circulation, bending and variation of ocean currents, current structures in near-equatorial regions, Antarctic circumpolar currents, ocean thermohaline circulation, deep-sea circulation and its relationship with the main thermocline, the relationship between divergent and convergent motions of seawater and up and down currents and Langmuir circulation and the like, mesoscale eddy and its energy conversion, special flow phenomena such as ice drift, the response of the ocean to wind stress and the like, circulation in near-shore sea regions, and the like.

An ocean circulation model is a numerical model that quantitatively describes ocean circulation and its changes, and reflects complex processes such as ocean dynamics, physics, and the interaction thereof by establishing mathematical and physical equations. An ocean circulation model discretizes continuous ocean fluid motions, and the space of the earth is divided into a three-dimensional grid structure in a longitudinal direction, a latitudinal direction, and a vertical direction, that is, a three-dimensional grid structure in the longitude direction, the latitude direction, and the vertical direction. Then, partial differential equations are solved through numerical integration.

With the constant deepening of ocean and climate change studies, ocean circulation models are gradually developing towards higher resolutions (a higher resolution indicates a finer grid), more physical processes (a number of equations increases), and a faster calculation speed. At present, a parallel framework of two levels, that is, horizontal division in the “longitudinal direction-latitudinal direction” and cyclic parallel computing in the “longitudinal direction (or latitudinal direction, or vertical direction)” is used to study an ocean circulation model.

However, the horizontal resolution of the current global ocean circulation model has increased from 5 degrees (about 500 km) to 0.1 degrees (about 10 km), and each increase in resolution leads to a geometric increase in a computing resource requirement and a computing volume. Generally, when the horizontal resolution is increased by 10 times, the computing volume is increased by 1000 times. Besides, with the increase of physical processes, the computing volume also increases. The above parallel framework of two levels limits the computing efficiency of the ocean circulation model in the “longitudinal direction-latitudinal direction-vertical direction” to some extent.

### SUMMARY

Embodiments of the present application aim to provide a data processing method and apparatus and an electronic device, to implement division of the three-dimensional space of the “longitudinal direction-latitudinal direction-vertical direction” in an ocean circulation model, and improve the computing efficiency of the ocean circulation model in the “longitudinal direction-latitudinal direction-vertical direction”.

According to a first aspect, a data processing method is provided, applied to ocean circulation model scenarios. The method may include:

dividing geographic regions of the earth in a longitudinal direction, a latitudinal direction, and a vertical direction according to a preset spatial resolution, to obtain a three-dimensional grid structure corresponding to the earth space and grid information of corresponding structures, where the grid information includes geographic regions of grids and regional data in the geographic regions;

dividing, according to a number of configured computing cores, the grids in the grid structure on grid planes corresponding to the longitudinal direction and the latitudinal direction in the grid structure, to obtain divided grid sub-structures corresponding to each computing core and regional data corresponding to corresponding structures;

for each computing core, dividing grids in the grid sub-structures in a first direction or the vertical direction based on a preset division policy, to obtain divided secondary grid sub-structures and regional data corresponding to corresponding structures, and allocating regional data corresponding to the secondary grid sub-structures to a primary computing unit of the computing core, where the first direction is the latitudinal direction or the vertical direction, and the secondary grid sub-structures include secondary grid sub-structures corresponding to the primary computing unit and secondary grid sub-structures corresponding to at least one computing subunit of the computing core; and

controlling, based on a preset allocation policy, the primary computing unit to allocate regional data corresponding to smaller secondary grid sub-structures to the at least one computing subunit, so that the primary computing unit and the at least one computing subunit compute service data in the allocated regional data based on a service requirement, where the smaller secondary grid sub-structures are obtained by the primary computing unit by dividing grids in the secondary grid sub-structures corresponding to the at least one computing subunit on grid planes corresponding to the second direction and the vertical direction, and the second direction is the latitudinal direction or the longitudinal direction.

In a possible implementation, the controlling the primary computing unit of the computing core to allocate regional data of smaller secondary grid sub-structures to the at least one computing subunit of the computing core includes:

for each computing subunit, controlling the primary computing unit of the computing core to divide grids in the smaller secondary grid sub-structures in a third direction according to a number of target processing units in the computing subunit, to obtain to-be-processed grid structure corresponding to each target processing unit and regional data corresponding to corresponding structures, and allocating regional data corresponding to the to-be-processed grid structure to the target processing unit, so that the target processing unit can compute the regional data corresponding to the to-be-processed grid structure, where the target processing unit is a processing unit that corresponds to a data type of the regional data and that has a vectorized instruction set function.

In a possible implementation, the primary computing unit of the computing core performs data communication with a primary computing unit of another computing core other than the computing core by using a configured information passing interface, and the method further includes:

transmitting regional data of target grids transmitted by the primary computing unit of the another computing core to the primary computing unit of the computing core, where the target grids are grids that have overlapped geographic regions with grids corresponding to the regional data allocated to the computing core; and

the allocating regional data corresponding to the secondary grid sub-structures to a primary computing unit of the computing core includes:

allocating the regional data of the secondary grid sub-structures and the regional data of the target grids transmitted by the primary computing unit of the another computing core to the primary computing unit of the computing core.

In a possible implementation, the dividing, according to a number of configured computing cores, the grids in the grid structure on grid planes corresponding to the longitudinal direction and the latitudinal direction in the grid structure, to obtain divided grid sub-structures corresponding to each computing core and regional data corresponding to corresponding structures includes:

determining to-be-computed grids in the grid structure based on a service computing requirement;

equally dividing, according to the number of configured computing cores, to-be-computed grids in the grid structure on grid planes corresponding to the longitudinal direction and the latitudinal direction in the grid structure, to obtain a to-be-computed grid set corresponding to each computing core;

randomly dividing not-to-be-computed grids in the grid structure on the grid planes corresponding to the longitudinal direction and the latitudinal direction in the grid structure, to obtain a grid set corresponding to the not-to-be-computed grids; and

based on the to-be-computed grid set corresponding to each computing core and the grid set corresponding to the not-to-be-computed grids, determining divided grid sub-structures corresponding to each computing core and regional data of corresponding structures.

In a possible implementation, the grid information further includes a region type of a geographic region of the grids, and the region type includes an ocean type; and

if the service computing requirement is a computing requirement of a target variable in an ocean circulation model, the determining to-be-computed grids in the grid structure based on a service computing requirement includes:

obtaining a region type corresponding to each grid in the grid structure; and

determining a grid whose region type is the ocean type as a to-be-computed grid.

In a possible implementation, the primary computing unit and the at least one computing subunit perform data communication with each other in a direct memory access manner.

In a possible implementation, the controlling, based on a preset allocation policy, the primary computing unit to allocate regional data corresponding to smaller secondary grid sub-structures to the at least one computing subunit includes:

based on a preset two-dimensional division policy in the second direction and the vertical direction, controlling the primary computing unit to divide grids in the secondary grid sub-structures corresponding to the at least one computing subunit on the grid planes corresponding to the second direction and the vertical direction, to obtain the smaller secondary grid sub-structures and regional data corresponding to corresponding structures, so that the primary computing unit allocates regional data corresponding to the divided smaller secondary grid sub-structures to the at least one computing subunit.

According to a second aspect, a data processing apparatus is provided. The apparatus may include:

a region division unit, configured to divide geographic regions of the earth in a longitudinal direction, a latitudinal direction, and a vertical direction according to a preset spatial resolution, to obtain a three-dimensional grid structure corresponding to the earth space and grid information of corresponding structures, where the grid information includes geographic regions of grids and regional data in the geographic regions;

a grid division unit, configured to: divide, according to a number of configured computing cores, the grids in the grid structure on grid planes corresponding to the longitudinal direction and the latitudinal direction in the grid structure, to obtain divided grid sub-structures corresponding to each computing core and regional data corresponding to corresponding structures; and

for each computing core, divide grids in the grid sub-structures in a first direction or the vertical direction based on a preset division policy, to obtain divided secondary grid sub-structures corresponding to a primary computing unit of the computing core and regional data corresponding to corresponding structures;

a data allocation unit, configured to allocate regional data corresponding to the secondary grid sub-structures to the primary computing unit of the computing core, where the first direction is the latitudinal direction or the vertical direction, and the secondary grid sub-structures include secondary grid sub-structures corresponding to the primary computing unit and secondary grid sub-structures corresponding to at least one computing subunit of the computing core; and

a control unit, configured to control, based on a preset allocation policy, the primary computing unit to allocate regional data corresponding to smaller secondary grid sub-structures to the at least one computing subunit, so that the primary computing unit and the at least one computing subunit compute service data in the allocated regional data based on a service requirement, where the smaller secondary grid sub-structures are obtained by the primary computing unit by dividing grids in the secondary grid sub-structures corresponding to the at least one computing subunit on grid planes corresponding to the second direction and the vertical direction, and the second direction is the latitudinal direction or the longitudinal direction.

In a possible implementation, the control unit is specifically configured to: for each computing subunit, control the primary computing unit of the computing core to divide grids in the smaller secondary grid sub-structures in a third direction according to a number of target processing units in the computing subunit, to obtain to-be-processed grid structure corresponding to each target processing unit and regional data corresponding to corresponding structures, and allocate regional data corresponding to the to-be-processed grid structure to the target processing unit, so that the target processing unit can compute the regional data corresponding to the to-be-processed grid structure, where the target processing unit is a processing unit that corresponds to a data type of the regional data and that has a vectorized instruction set function.

In a possible implementation, the primary computing unit of the computing core performs data communication with a primary computing unit of another computing core other than the computing core by using a configured information passing interface, and the apparatus further includes: a transmission unit;

the transmission unit is configured to transmit regional data of target grids transmitted by the primary computing unit of the another computing core to the primary computing unit of the computing core, where the target grids are grids that have overlapped geographic regions with grids corresponding to the regional data allocated to the computing core; and

the data allocation unit is specifically configured to allocate the regional data of the secondary grid sub-structures and the regional data of the target grids transmitted by the primary computing unit of the another computing core to the primary computing unit of the corresponding computing core.

In a possible implementation, the grid division unit is specifically configured to:

determine to-be-computed grids in the grid structure based on a service computing requirement;

equally divide, according to the number of configured computing cores, to-be-computed grids in the grid structure on grid planes corresponding to the longitudinal direction and the latitudinal direction in the grid structure, to obtain a to-be-computed grid set corresponding to each computing core;

randomly divide not-to-be-computed grids in the grid structure on the grid planes corresponding to the longitudinal direction and the latitudinal direction in the grid structure, to obtain a grid set corresponding to the not-to-be-computed grids; and

based on the to-be-computed grid set corresponding to each computing core and the grid set corresponding to the not-to-be-computed grids, determine divided grid sub-structures corresponding to each computing core and regional data of corresponding structures.

In a possible implementation, the grid information further includes a region type of a geographic region of the grids, and the region type includes an ocean type; and

if the service computing requirement is a computing requirement of a target variable in an ocean circulation model, the grid division unit is specifically configured to:

obtain a region type corresponding to each grid in the grid structure; and

determine a grid whose region type is the ocean type as a to-be-computed grid.

In a possible implementation, the primary computing unit and the at least one computing subunit perform data communication with each other in a direct memory access manner.

In a possible implementation, the control unit is specifically configured to:

based on a preset two-dimensional division policy in the second direction and the vertical direction, control the primary computing unit to divide grids in the secondary grid sub-structures corresponding to the at least one computing subunit on the grid planes corresponding to the second direction and the vertical direction, to obtain the smaller secondary grid sub-structures and regional data corresponding to corresponding structures, so that the primary computing unit allocates regional data corresponding to the divided smaller secondary grid sub-structures to the at least one computing subunit.

According to a third aspect, an electronic device is provided, including a processor, a communication interface, a memory, and a communication bus, where the processor, the communication interface, and the memory communicate with each other through the communication bus; where

the memory is configured to store a computer program; and

the processor is configured to execute the program stored in the memory, to perform steps of the method according to any implementation of the first aspect.

According to a fourth aspect, a computer-readable storage medium is provided, storing a computer program. When the computer program is executed by a processor, steps of the method according to any implementation of the first aspect are performed.

In the data processing method provided in the embodiments of the present application, grids in the three-dimensional grid structure corresponding to the space of the earth are divided first at three levels, to implement parallel computing of the space of the earth at three levels and improve the parallel computing efficiency. Further, grids are divided at the fourth level in each computing subunit, to implement parallel computing of the space of the earth at four levels and improve the computing efficiency of the ocean circulation model in the “longitudinal direction-latitudinal direction-vertical direction”.

### BRIEF DESCRIPTION OF THE DRAWING

To describe the technical solutions in the embodiments of the present application more clearly, the following briefly describes the accompanying drawings required in the embodiments of the present application. It should be understood that the following drawings only show some embodiments of the present application, and therefore should not be regarded as a limitation on the scope. A person of ordinary skill in the art may still derive other drawings from these accompanying drawings without creative efforts.

FIG. 1 is a schematic structural diagram of a new generation of Sunway many-core processor according to an embodiment of the present application;

FIG. 2 is a schematic diagram of a process of parallel data processing in an ocean circulation model according to an embodiment of the present application;

FIG. 3 is a schematic flowchart of a data processing method according to an embodiment of the present application;

FIG. 4 is a schematic diagram of a strong scalability test result according to an embodiment of the present application;

FIG. 5 is a schematic diagram of a weak scalability test result according to an embodiment of the present application;

FIG. 6 is a schematic structural diagram of a data processing apparatus according to an embodiment of the present application; and

FIG. 7 is a schematic structural diagram of an electronic device according to an embodiment of the present application.

### DESCRIPTION OF THE EMBODIMENTS

The following clearly and completely describes the technical solutions in the embodiments of the present application with reference to the accompanying drawings in the embodiments of the present application. Apparently, the described embodiments are some but not all of the embodiments of the present application. All other embodiments obtained by persons of ordinary skill in the art based on the embodiments of the present application without creative works shall fall within the protection scope of the present application.

For ease of understanding, the following describes nouns used in the embodiments of the present invention.

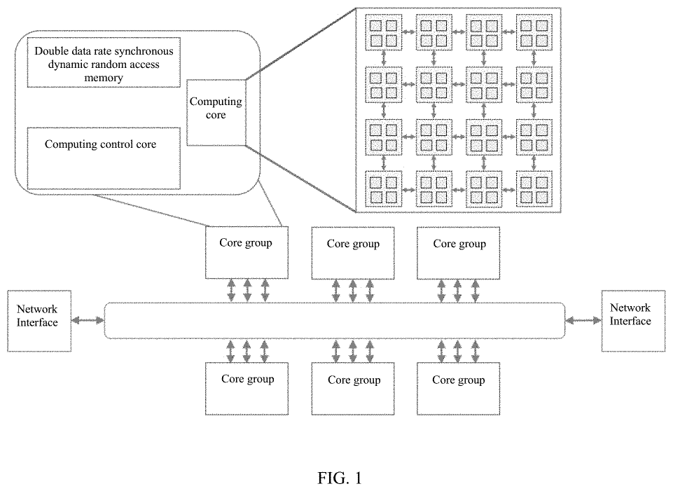

A new generation of Sunway many-core processor (model SW26010 upgrade version) integrates 6 core groups (CG) (or referred to as “computing cores”), and the 6 computing cores are connected through a loop network (Loop network). Each computing core CG includes a double data rate (DDR) synchronous dynamic random access memory with a memory interface (MI), a computing control core (Management Processing Element, MPE) (or referred to as “primary computing unit”), and an 8*8 computing core (Computing Processing Element, CPE) (or referred to as “computing subunit”) array. These components are connected through a loop network, as shown in FIG. 1. The processor has a 512-bit single instruction multiple data (SIMD) instruction set and can compute 8 double-precision numbers at a time. Therefore, the processor is a processing unit with at least one vectorized instruction set function.

A primary computing unit MPE has an independent operating system and is mainly configured to perform functions such as task scheduling, allocation, control, communication, IO, and computing. A computing subunit CPE is mainly configured to perform computing. Computing subunits CPEs of the computing core CG are arranged in an 8*8 array. The computing subunits CPEs interact with each other and the computing subunit CPE and the primary computing unit MPE interact with each other. The computing subunits and the primary computing unit are interconnected through a network in an array.

The primary computing unit MPE performs data communication by using a message passing interface (MPI). Any two computing subunits CPEs in the computing subunit CPE array can perform data communication through one of remote memory access (RMA), P2P, and collective communication. The primary computing unit MPE and the computing subunit CPE perform data communication through direct memory access (DMA).

The data processing method provided in the embodiments of the present application can be applied to ocean circulation model scenarios, and can be specifically applied to the above new generation of Sunway many-core processor to study an ocean circulation model. The data processing method can be used to obtain real-time three-dimensional ocean values such as ocean temperatures and salinity, sea surface dynamic heights, ocean currents, and sea ice density, and provide computing performance support for the study of the ocean circulation model.

It should be noted that, the data processing method provided in the embodiments of the present application may also be applied to another processor having multiple computing units. This is not limited in the present application.

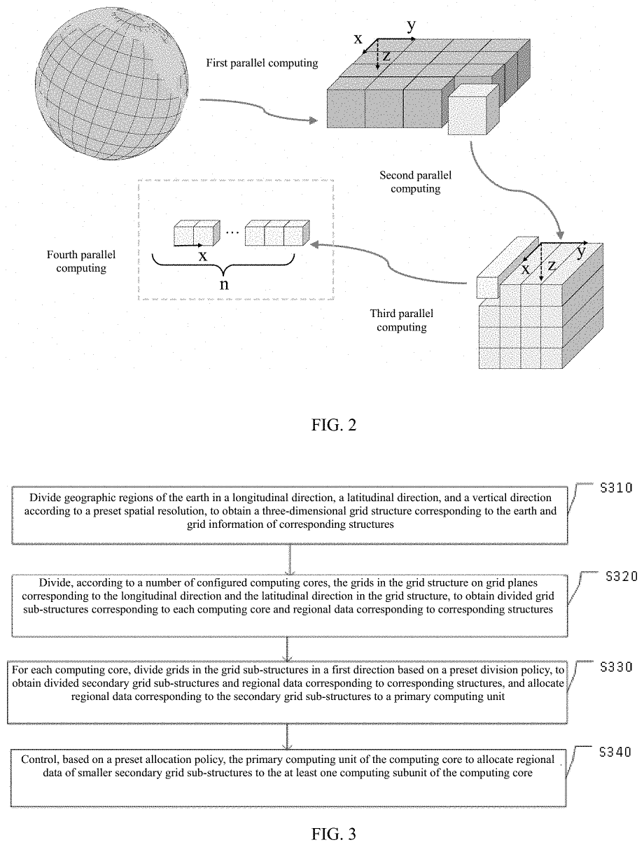

As shown in FIG. 2, in combination with the characteristics of the ocean circulation model, in the data processing method provided in the embodiments of the present application, a parallel framework of four levels of the ocean circulation model, that is, the first-level parallel computing—longitudinal direction-latitudinal direction horizontal spatial division based on a primary computing unit, the second-level parallel computing—longitudinal direction-latitudinal direction horizontal spatial division based on the primary computing unit and the computing subunit, the third-level parallel computing—longitudinal direction/latitudinal direction-vertical direction horizontal spatial division based on computing subunits, and the fourth-level parallel computing—longitudinal direction/latitudinal direction spatial division based on a vectorized instruction set is mainly designed. This implements division of the three-dimensional space of the “longitudinal direction-latitudinal direction-vertical direction” in an ocean circulation model, and improves the computing efficiency of the ocean circulation model in the “longitudinal direction-latitudinal direction-vertical direction”.

The longitudinal direction is a longitude direction based on the space of the earth, such as the x-axis direction. The latitudinal direction is a latitude direction based on the space of the earth, such as the y-axis direction. The vertical direction is a vertical direction pointing to the center of the earth based on the space of the earth, such as the z-axis direction. n is a number of x-axis directions.

The preferred embodiments of the present application will be described below with reference to the accompanying drawings of the specification. It should be understood that the preferred embodiments described herein are only used to illustrate the present invention, instead of limiting the present invention. The embodiments of the present application and features in the embodiments can be combined with each other.

FIG. 3 is a schematic flowchart of a data processing method according to an embodiment of the present application. As shown in FIG. 3, the method may include:

Step S310: Divide geographic regions of the earth in a longitudinal direction, a latitudinal direction, and a vertical direction according to a preset spatial resolution, to obtain a three-dimensional grid structure corresponding to the earth and grid information of corresponding structures.

Sizes of divided grids depend on the preset spatial resolution. A higher resolution indicates finer grids, that is, smaller grid sizes.

In a specific implementation, referring to FIG. 2, the geographic regions of the earth are divided in the longitudinal direction, the latitudinal direction, and the vertical direction according to the preset spatial resolution, to obtain the three-dimensional grid structure corresponding to the earth. Each geographic region is a grid in the grid structure.

Since a geographic region has a geographic location, a corresponding grid also has the same geographic location, and the corresponding grid also has regional data in the geographic region.

For example, a target geographic region is an ocean region owned by country A on a plane corresponding to the longitudinal direction and the latitudinal direction, and the region is a region encircled by a geographic location point a, a geographic location point b, a geographic location point c, and a geographic location point d depending on longitudes and latitudes. That is, on the plane corresponding to the longitudinal direction and the latitudinal direction, a size of a grid corresponding to the target geographic region represents the ocean region owned by country A. In this case, the grid includes regional data of the ocean region, such as ocean data such as temperatures and salinity, sea surface dynamic heights, ocean currents, and sea ice density.

If the ocean circulation model needs to study ocean temperatures, ocean temperature data in the regional data is service data included in the grid.

For example, the ocean circulation model studies ocean temperatures. In this case, service data is ocean temperatures. When the size of the target geographic region remains unchanged, as the ocean depth (that is, the vertical height) increases, the ocean temperature gradually decreases. Therefore, the grid corresponding to the target geographic region includes ocean temperatures corresponding to different vertical heights.

That is, the grid information of each grid includes a geographic region of the grid and service data in the corresponding geographic region.

Step S320: Divide, according to a number of configured computing cores, the grids in the grid structure on grid planes corresponding to the longitudinal direction and the latitudinal direction in the grid structure, to obtain divided grid sub-structures corresponding to each computing core and regional data corresponding to corresponding structures.

With reference to FIG. 2, since the scale of the grids of the x-axis and the y-axis is much larger than those of the z-axis, to reduce the computing volume of the grid structure, the grids in the grid structure can be first divided according to grid planes of the longitudinal direction and the latitudinal direction, that is, the grids in the grid structure are divided along the x-axis and the y-axis, to divide regional data in different geographical regions. In addition, the divided grids are allocated to different primary computing units, that is, different MPI processes, so that different primary computing units perform parallel computing on the regional data of different allocated grids.

In a specific implementation, based on the obtained three-dimensional grid structure, the grids in the grid structure are divided according to the number of configured computing cores on the grid planes corresponding to the longitudinal direction and the latitudinal direction, that is, the grids in the grid structure are divided into the same number of grid sub-structures as the number of configured computing cores, to obtain the regional data corresponding to each grid sub-structure. In addition, each grid sub-structure obtained by division and the regional data corresponding to the corresponding structure are allocated to each computing core.

Further, since regional data of some grids in the obtained three-dimensional grid structure may not include service data, these grids can be called invalid grids, that is, grids that are not related to a service computing requirement. Therefore, to obtain precise data of a target variable satisfying the service computing requirement, to-be-computed grids related to the target variable in the grid structure need to be first determined. Details are as follows:

If the service computing requirement is a computing requirement of a target variable in the ocean circulation model, a region type corresponding to each grid in the grid structure is obtained. The region type is a region type of a geographic region of the grid. The region type of the geographic region may include an ocean region, a land region, a plain region, a mountain forest region, and the like. Then, a grid whose region type is the ocean type is determined as a to-be-computed grid.

In some embodiments, to balance the load of the computing cores and improve the computing speed, after to-be-computed grids are determined, to-be-computed grids in the grid structure may be equally divided according to the number of configured computing cores on grid planes corresponding to the longitudinal direction and the latitudinal direction in the grid structure, to obtain a to-be-computed grid set corresponding to each computing core.

At the same time, not-to-be-computed grids (that is, invalid grids) in the grid structure are randomly divided on the grid planes corresponding to the longitudinal direction and the latitudinal direction in the grid structure, to obtain a grid set corresponding to the not-to-be-computed grids.

Divided grid sub-structures corresponding to each computing core and regional data of corresponding structures are determined based on the to-be-computed grid set corresponding to each computing core and the grid set corresponding to the not-to-be-computed grids.

In the above implementation, only regional data of the to-be-computed grid is computed, and regional data of the invalid grid is not computed. Therefore, the computing volume of each computing core only depends on the number of to-be-computed grids, and to-be-computed grids are equally divided according to the number of computing cores, so that the quantities of to-be-computed grids allocated to computing cores are balanced, so as to balance the load of the computing cores.

It should be noted that, in the above implementation, it needs to be considered whether the quantities of to-be-computed grids allocated to computing cores are balanced, and the quantities of invalid grids allocated to computing cores do not need to be considered. For example, all invalid grids can be allocated to one computing core or can be randomly allocated to multiple computing cores, that is, the allocation method is not limited.

Step S330: For each computing core, divide grids in the grid sub-structures in a first direction based on a preset division policy, to obtain divided secondary grid sub-structures and regional data corresponding to corresponding structures, and allocate regional data corresponding to the secondary grid sub-structures to a primary computing unit.

The first direction is the latitudinal direction or the vertical direction.

In a specific implementation, to balance the load of the primary computing unit and at least one computing subunit of each computing core, the preset division policy may be configured according to the number of computing units of the computing core, such as a policy of dividing according to the number of computing units.

Grids in the grid sub-structures are divided in the latitudinal direction or the vertical direction based on the preset division policy, to obtain divided secondary grid sub-structures and regional data corresponding to corresponding structures, and regional data corresponding to the secondary grid sub-structures is allocated to a corresponding primary computing unit. The secondary grid sub-structures include secondary grid sub-structures corresponding to the primary computing unit and secondary grid sub-structures corresponding to at least one computing subunit of the computing core.

In some embodiments, a primary computing unit of another computing core other than the computing core transmits the regional data of the target grid to the primary computing unit of the computing core through a data communication method of a message passing interface MPI. The target grid is a grid with an overlapped geographic region with a grid corresponding to the regional data allocated to the computing core, that is, a geographic region of a grid corresponding to the computing core overlaps with a geographic region of the target grid. Overlapping can be that two geographic regions partially overlap with each other.

Therefore, after the divided secondary grid sub-structures and the regional data corresponding to the corresponding structures are obtained, the regional data of the secondary grid sub-structures and the regional data of the target grid transmitted by the primary computing unit of the another computing core are allocated to the primary computing unit of the computing core.

In the above implementation, when the primary computing unit is responsible for data exchange with primary computing units of different computing cores, the primary computing unit performs data communication with other primary computing units through the MPI method.

Step S340: Control, based on a preset allocation policy, the primary computing unit to allocate regional data corresponding to smaller secondary grid sub-structures to the at least one computing subunit.

The second direction is the latitudinal direction or the longitudinal direction. The preset allocation policy can be based on a storage capacity of an empirical value device or a computing subunit. A two-dimensional division policy of the second direction and the vertical direction is set, that is, a two-dimensional division policy of the latitudinal direction/the longitudinal direction and the vertical direction; or a division policy is set according to a number of computing units. This may be specifically set according to an actual status and is not limited in the present application.

A two-dimensional division policy of the latitudinal direction and the vertical direction is used as an example. The two-dimensional division policy is a policy of keeping the grid structure in the longitudinal direction unchanged and dividing grids in the corresponding grid structure according to preset two-dimensional numerical values (for example, 3×4 two-dimensional numerical values) on the grid planes corresponding to the latitudinal direction and the vertical direction.

In a specific implementation, for example, the preset allocation policy may be a preset two-dimensional division policy of the second direction and the vertical direction. Based on the preset two-dimensional division policy corresponding to the second direction and the vertical direction, the primary computing unit of the computing core is controlled to divide grids in the secondary grid sub-structures corresponding to the at least one computing subunit on the grid planes corresponding to the second direction and the vertical direction, to obtain the smaller secondary grid sub-structures and regional data corresponding to corresponding structures. After the primary computing unit allocates regional data corresponding to the divided smaller secondary grid sub-structures to the at least one computing subunit, both the primary computing unit and the at least one computing subunit compute service data in the allocated region data based on a service requirement.

Further, since each computing subunit computes data through a parallel method of data vectorization, for each computing subunit, the primary computing unit of the computing core is controlled to divide grids in the smaller secondary grid sub-structures in a third direction according to a number of target processing units in the computing subunit, to obtain to-be-processed grid structure corresponding to each target processing unit and regional data corresponding to corresponding structures, and regional data corresponding to the to-be-processed grid structure is allocated to the target processing unit, so that the target processing unit can compute the regional data corresponding to the to-be-processed grid structure.

The target processing unit is a processing unit that corresponds to a data type of the regional data and that has a vectorized instruction set function.

In the above implementation, since the computing subunit cannot perform communication across computing cores, the primary computing unit performs data communication with the computing subunit through DMA when the primary computing unit is responsible for fine-grained grid division of the computing subunit. Computing subunits of a same computing core perform data communication through RMA. Therefore, in combination with the previous step, in the embodiments of the present application, data may be exchanged through a parallel manner of DMA+MPI+RMA.

In an example, after the three-dimensional grid structure 752*502*65 (longitudinal direction-latitudinal direction-vertical direction) corresponding to the earth and the grid information of the corresponding structure are obtained, in the embodiments of the present application, division of four levels may be performed to implement parallel processing of data. Details are as follows:

First level: The new generation of Sunway many-core processor has 128 computing cores, and the 128 computing cores are divided into 16*8 two-dimensional matrix columns correspondingly responsible for dividing grids in a grid structure on 752*502 grid planes corresponding to the longitudinal direction and the latitudinal direction. Therefore, on the 752*502 grid planes corresponding to the longitudinal direction and the latitudinal direction, each computing core is responsible for about 49*65 (including boundary elements) grids on average. Therefore, a grid sub-structure including 49*65*65 grids can be actually allocated to each core group. At the same time, computing cores exchange data through the MPI communication mechanism.

Second level: Since a computing core includes one primary computing unit and multiple computing subunits, according to a number of computing units of the computing core, grids in a grid sub-structure 49*65*65 can be divided in the vertical direction in a manner of “vertical direction” 1+64, to obtain a secondary grid sub-structure 49*65*1 that the primary computing unit is responsible for and regional data corresponding to corresponding structures, and a secondary grid sub-structure 49*65*64 that the multiple computing subunits are responsible for and regional data corresponding to corresponding structures.

Alternatively, according to a number of computing units of the computing core, grids in a grid sub-structure 49*65*65 are divided in the latitudinal direction in a manner of “latitudinal direction” 1+64, to obtain a secondary grid sub-structure 49*1*65 that the primary computing unit is responsible for and regional data corresponding to corresponding structures, and a secondary grid sub-structure 49*64*65 that the multiple computing subunits are responsible for and regional data corresponding to corresponding structures.

After the division, regional data corresponding to the divided secondary grid sub-structures is all allocated to a corresponding primary computing unit, so that a primary computing unit allocates grid data to a computing subunit that the primary computing unit is responsible for.

Third level: Based on a storage capacity of the computing subunit, a 16*2 two-dimensional division policy of the second direction and the vertical direction is set. For example, the secondary grid sub-structure that the multiple computing subunits are responsible for and that is obtained at the second level is 49*65*64 and the second direction is the latitudinal direction. The implementation of the third level is described in detail.

The grids in the secondary grid sub-structure 49*65*64 are divided in the latitudinal direction and the vertical direction according to the 16*2 two-dimensional division policy on the grid planes corresponding to the latitudinal direction and the vertical direction, to obtain a smaller secondary grid sub-structure 49*32*4 (or 49*33*4) and regional data corresponding to corresponding structures.

Fourth level: According to a number of target processing units of the computing subunit, the grids in the smaller secondary grid sub-structure 49*32*4 (or 49*33*4) are divided in the longitudinal direction, to obtain a to-be-processed grid structure corresponding to each target processing unit and regional data corresponding to corresponding structure. For example, if the number of target processing units is 49, the to-be-processed grid structure corresponding to each target processing unit is 1*32*4 (or 1*33*4), thereby further improving the parallel data computing capability.

In the data processing method provided in the embodiments of the present application, grids in the three-dimensional grid structure corresponding to the space of the earth are divided first at three levels, to implement parallel computing of the space of the earth at three levels. Besides, grids are divided at the fourth level in each computing subunit, to further implement parallel computing of the space of the earth at four levels and improve the computing efficiency of the ocean circulation model in the “longitudinal direction-latitudinal direction-vertical direction”.

Further, this application can be applied to the ocean circulation model NEMO, and a new version of swNEMO suitable for a new generation of Sunway many-core processor is developed, to implement parallel computing of four levels of the NEMO on a supercomputer including a new generation of Sunway many-core processor. Subsequently, a benchmark test named GYRE-PISCES is chosen to test the performance of swNEMO.

A simulated region of GYRE-PISCES is a closed rectangular basin on the beta plane, which is 3180 km long, 2120 km wide, and 4 km deep, is centered at 30° N, and rotates by 45°. This benchmark represents an ideal North Atlantic or North Pacific basin. Further, in consideration of the impact of the third-level grid structure in the global model on periodic conditions of the east and west oceans and Arctic global ocean folding, the BENCH option is activated in the benchmark test to include these periodic conditions, and the impact of the third-level grid structure on the communication pattern of the global ocean is reproduced. From the perspective of computing costs and computing properties, this is equivalent to a global ocean with the third-level grid structure and the same number of grids. In the following, the horizontal resolution is a horizontal resolution equivalent to the global ocean after conversion.

Experiments with three horizontal resolutions 2 km, 1 km, and 500 m are designed for strong scalability analysis. Each experiment includes 8 different parallel scales. Speedup refers to division of clock times at different scales by a baseline record at a minimum scale with 2,129,920 computing cores. For weak scalability analysis, experiments with 8 resolutions are designed. All experiments are run for one modeling day without I/O.

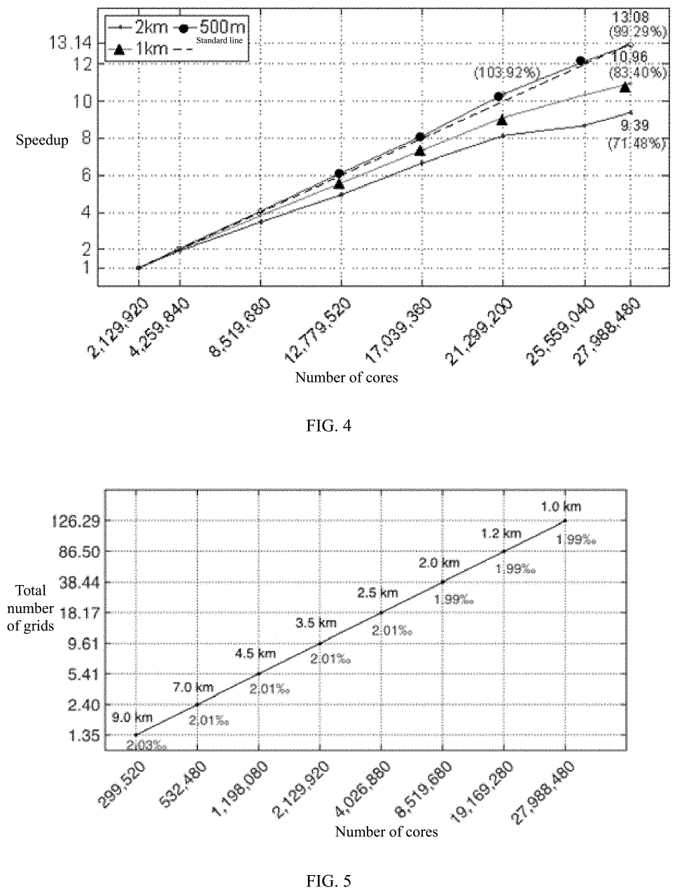

Strong scalability test analysis: Experiments are performed at 2 km, 1 km, and 500 m resolutions, and the number of computing cores is increased from 2,129,920 to 27,988,480. In the ocean circulation model, there is a one-to-one correspondence between the resolution and the grid number. The 2 km, 1 km, and 500 m resolutions correspond to grid numbers of the global horizontal plane (longitude-latitude): 24002×16002, 43502×29002, and 82502×55002. The vertical-layer grid number 128 is a common exemplary computing specification. Therefore, the grid numbers for resolutions 2 km, 1 km, and 500 m are 24002×16002×128, 43502×29002×128, and 82502×55002×128 respectively. 2,129,920 computing cores are set as the benchmark for strong scalability, and the final parallel efficiency is 74.18%, 83.40%, and 99.29% respectively, as shown in FIG. 4. As can be seen from this, all three resolutions have very desirable strong scalability, and the hyper-scale speedup is still close to be linear. In the test of the highest resolution 500 m, 27,988,480 computing cores can still achieve parallel efficiency up to 99.29%.

Weak scalability test analysis: Weak scalability analysis is performed at resolutions 9 km, 7 km, 4.5 km, 3.5 km, 2.5 km, 2.0 km, 1.2 km, and 1.0 km.

In weak scalability performance analysis, theoretically, the floating-point computing efficiency of an average single computing core remains unchanged when processing the same number of grids within the core. Therefore, change trends in two aspects need to be considered in weak scalability analysis: 1. The total number of grids changes along with the computing core; and 2. The overall computing efficiency changes along with the computing core.

As shown in FIG. 5, the horizontal coordinate represents the number of computing cores, and the vertical coordinate represents an increasing relationship when the total number of grids changes along with the computing core. As can be seen from FIG. 5, the total number of grids (computed grid points number) shows an approximate linear trend along with the change of the number of computing cores (Number of cores), that is, the number of grids processed by a single core (that is, the slope D of the linear graph) is almost constant. The percentage value in FIG. 5 represents the total computing efficiency under this scale. As can be seen from the computing efficiency value in FIG. 5, the total computing efficiency under different computing scales is almost linear. 9 km is used as the test benchmark, and the theoretical constant computing efficiency of weak scalability performance is 2.03/1000. As can be seen from FIG. 5, the computing efficiency is 1.99/1000 when the resolution increases to 1 km, and decreases by 0.04/1000 compared with the theoretical value, that is, the decrease ratio is less than 2%. The results show that the performance is stable at different resolutions and the computing efficiency at the resolution 1 km is still 1.99/1000. The trend approximately close to the baseline indicates that the swNEMO has excellent weak scalability, as shown in FIG. 5.

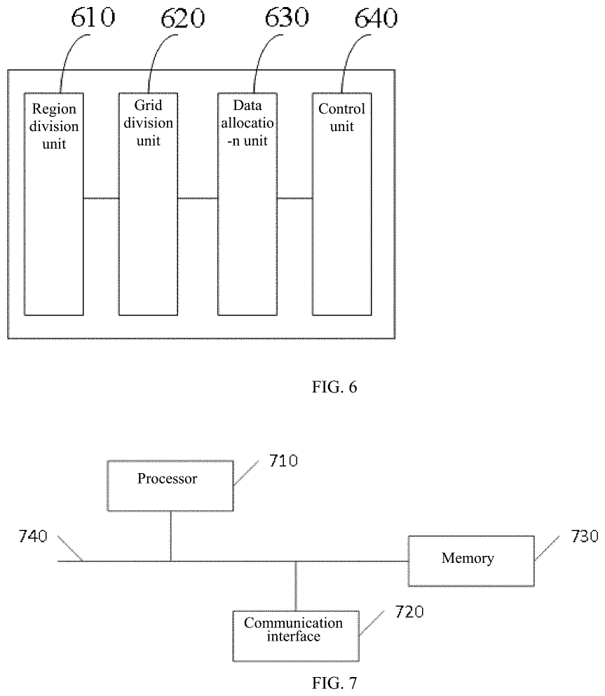

Corresponding to the above method, an embodiment of the present invention further provides a data processing apparatus. As shown in FIG. 6, the apparatus includes: a region division unit 610, a grid division unit 620, a data allocation unit 630, and a control unit 640.

The region division unit 610 is configured to divide geographic regions of the earth in a longitudinal direction, a latitudinal direction, and a vertical direction according to a preset spatial resolution, to obtain a three-dimensional grid structure corresponding to the earth space and grid information of corresponding structures, where the grid information includes geographic regions of grids and regional data in the geographic regions.

The grid division unit 620 is configured to: divide, according to a number of configured computing cores, the grids in the grid structure on grid planes corresponding to the longitudinal direction and the latitudinal direction in the grid structure, to obtain divided grid sub-structures corresponding to each computing core and regional data corresponding to corresponding structures; and

for each computing core, divide grids in the grid sub-structures in a first direction or the vertical direction based on a preset division policy, to obtain divided secondary grid sub-structures and regional data corresponding to corresponding structures.

The data allocation unit 630 is configured to allocate regional data corresponding to the secondary grid sub-structures to the primary computing unit of the computing core, where the first direction is the latitudinal direction or the vertical direction, and the secondary grid sub-structures include secondary grid sub-structures corresponding to the primary computing unit and secondary grid sub-structures corresponding to at least one computing subunit of the computing core.

The control unit 640 is configured to control, based on a preset allocation policy, the primary computing unit to allocate regional data corresponding to smaller secondary grid sub-structures to the at least one computing subunit, so that the primary computing unit and the at least one computing subunit compute service data in the allocated regional data based on a service requirement, where the smaller secondary grid sub-structures are obtained by the primary computing unit by dividing grids in the secondary grid sub-structures corresponding to the at least one computing subunit on grid planes corresponding to the second direction and the vertical direction, and the second direction is the latitudinal direction or the longitudinal direction.

In a possible implementation, the control unit 640 is specifically configured to: for each computing subunit, control the primary computing unit of the computing core to divide grids in the smaller secondary grid sub-structures in a third direction according to a number of target processing units in the computing subunit, to obtain to-be-processed grid structure corresponding to each target processing unit and regional data corresponding to corresponding structures, and allocate regional data corresponding to the to-be-processed grid structure to the target processing unit, so that the target processing unit can compute the regional data corresponding to the to-be-processed grid structure, where the target processing unit is a processing unit that corresponds to a data type of the regional data and that has a vectorized instruction set function.

In a possible implementation, the primary computing unit of the computing core performs data communication with a primary computing unit of another computing core other than the computing core by using a configured information passing interface; and

the apparatus further includes: a transmission unit 650;

the transmission unit 650 is configured to transmit regional data of target grids transmitted by the primary computing unit of the another computing core to the primary computing unit of the computing core, where the target grids are grids that have overlapped geographic regions with grids corresponding to the regional data allocated to the computing core; and

the data allocation unit 630 is specifically configured to allocate the regional data of the secondary grid sub-structures and the regional data of the target grids transmitted by the primary computing unit of the another computing core to the primary computing unit of the computing core.

In a possible implementation, the grid division unit 620 is specifically configured to:

determine to-be-computed grids in the grid structure based on a service computing requirement;

equally divide, according to the number of configured computing cores, to-be-computed grids in the grid structure on grid planes corresponding to the longitudinal direction and the latitudinal direction in the grid structure, to obtain a to-be-computed grid set corresponding to each computing core;

randomly divide not-to-be-computed grids in the grid structure on the grid planes corresponding to the longitudinal direction and the latitudinal direction in the grid structure, to obtain a grid set corresponding to the not-to-be-computed grids; and

based on the to-be-computed grid set corresponding to each computing core and the grid set corresponding to the not-to-be-computed grids, determine divided grid sub-structures corresponding to each computing core and regional data of corresponding structures.

In a possible implementation, the grid information further includes a region type of a geographic region of the grids, and the region type includes an ocean type; and

if the service computing requirement is a computing requirement of a target variable in an ocean circulation model, the grid division unit 620 is specifically configured to:

obtain a region type corresponding to each grid in the grid structure; and

determine a grid whose region type is the ocean type as a to-be-computed grid.

In a possible implementation, the primary computing unit and the at least one computing subunit perform data communication with each other in a direct memory access manner.

In a possible implementation, the control unit 640 is specifically configured to:

based on a preset two-dimensional division policy in the second direction and the vertical direction, control the primary computing unit to divide grids in the secondary grid sub-structures corresponding to the at least one computing subunit on the grid planes corresponding to the second direction and the vertical direction, to obtain the smaller secondary grid sub-structures and regional data corresponding to corresponding structures, so that the primary computing unit allocates regional data corresponding to the divided smaller secondary grid sub-structures to the at least one computing subunit.

Functions of functional units of the data processing apparatus provided in the above embodiments of the present invention can be implemented through steps of the above method. Therefore, specific working processes and beneficial effects of units in the data processing apparatus provided in the embodiments of the present invention are not repeated herein.

An embodiment of the present invention further provides an electronic device. As shown in FIG. 7, the electronic device includes a processor 710, a communication interface 720, a memory 730, and a communication bus 740. The processor 710, the communication interface 720, and the memory 730 communicate with each other through the communication bus 740.

The memory 730 is configured to store a computer program.

The processor 710 is configured to execute the program stored in the memory 730, to perform the following steps:

dividing geographic regions of the earth in a longitudinal direction, a latitudinal direction, and a vertical direction according to a preset spatial resolution, to obtain a three-dimensional grid structure corresponding to the earth space and grid information of corresponding structures, where the grid information includes geographic regions of grids and regional data in the geographic regions;

dividing, according to a number of configured computing cores, the grids in the grid structure on grid planes corresponding to the longitudinal direction and the latitudinal direction in the grid structure, to obtain divided grid sub-structures corresponding to each computing core and regional data corresponding to corresponding structures;

for each computing core, dividing grids in the grid sub-structures in a first direction or the vertical direction based on a preset division policy, to obtain divided secondary grid sub-structures and regional data corresponding to corresponding structures, and allocating regional data corresponding to the secondary grid sub-structures to a primary computing unit of the computing core, where the first direction is the latitudinal direction or the vertical direction, and the secondary grid sub-structures include secondary grid sub-structures corresponding to the primary computing unit and secondary grid sub-structures corresponding to at least one computing subunit of the computing core; and

controlling, based on a preset allocation policy, the primary computing unit to allocate regional data corresponding to smaller secondary grid sub-structures to the at least one computing subunit, so that the primary computing unit and the at least one computing subunit compute service data in the allocated regional data based on a service requirement, where the smaller secondary grid sub-structures are obtained by the primary computing unit by dividing grids in the secondary grid sub-structures corresponding to the at least one computing subunit on grid planes corresponding to the second direction and the vertical direction, and the second direction is the latitudinal direction or the longitudinal direction.

In a possible implementation, the controlling the primary computing unit of the computing core to allocate regional data of smaller secondary grid sub-structures to the at least one computing subunit of the computing core includes:

for each computing subunit, controlling the primary computing unit of the computing core to divide grids in the smaller secondary grid sub-structures in a third direction according to a number of target processing units in the computing subunit, to obtain to-be-processed grid structure corresponding to each target processing unit and regional data corresponding to corresponding structures, and allocating regional data corresponding to the to-be-processed grid structure to the target processing unit, so that the target processing unit can compute the regional data corresponding to the to-be-processed grid structure, where the target processing unit is a processing unit that corresponds to a data type of the regional data and that has a vectorized instruction set function.

In a possible implementation, the primary computing unit of the computing core performs data communication with a primary computing unit of another computing core other than the computing core by using a configured information passing interface, and the method further includes:

transmitting regional data of target grids transmitted by the primary computing unit of the another computing core to the primary computing unit of the computing core, where the target grids are grids that have overlapped geographic regions with grids corresponding to the regional data allocated to the computing core; and

the allocating regional data corresponding to the secondary grid sub-structures to a primary computing unit of the computing core includes:

allocating the regional data of the secondary grid sub-structures and the regional data of the target grids transmitted by the primary computing unit of the another computing core to the primary computing unit of the computing core.

In a possible implementation, the dividing, according to a number of configured computing cores, the grids in the grid structure on grid planes corresponding to the longitudinal direction and the latitudinal direction in the grid structure, to obtain divided grid sub-structures corresponding to each computing core and regional data corresponding to corresponding structures includes:

determining to-be-computed grids in the grid structure based on a service computing requirement;

equally dividing, according to the number of configured computing cores, to-be-computed grids in the grid structure on grid planes corresponding to the longitudinal direction and the latitudinal direction in the grid structure, to obtain a to-be-computed grid set corresponding to each computing core;

randomly dividing not-to-be-computed grids in the grid structure on the grid planes corresponding to the longitudinal direction and the latitudinal direction in the grid structure, to obtain a grid set corresponding to the not-to-be-computed grids; and

based on the to-be-computed grid set corresponding to each computing core and the grid set corresponding to the not-to-be-computed grids, determining divided grid sub-structures corresponding to each computing core and regional data of corresponding structures.

In a possible implementation, the grid information further includes a region type of a geographic region of the grids, and the region type includes an ocean type; and

if the service computing requirement is a computing requirement of a target variable in an ocean circulation model, the determining to-be-computed grids in the grid structure based on a service computing requirement includes:

obtaining a region type corresponding to each grid in the grid structure; and

determining a grid whose region type is the ocean type as a to-be-computed grid.

In a possible implementation, the primary computing unit and the at least one computing subunit perform data communication with each other in a direct memory access manner.

In a possible implementation, the controlling, based on a preset allocation policy, the primary computing unit to allocate regional data corresponding to smaller secondary grid sub-structures to the at least one computing subunit includes:

based on a preset two-dimensional division policy in the second direction and the vertical direction, controlling the primary computing unit to divide grids in the secondary grid sub-structures corresponding to the at least one computing subunit on the grid planes corresponding to the second direction and the vertical direction, to obtain the smaller secondary grid sub-structures and regional data corresponding to corresponding structures, so that the primary computing unit allocates regional data corresponding to the divided smaller secondary grid sub-structures to the at least one computing subunit.

The communication bus may be a peripheral component interconnect (PCI) bus, or an extended industry standard architecture (EISA) bus, or the like. The communication bus can be classified into an address bus, a data bus, a control bus, and the like. For ease of illustration, only one thick line is used in the figure, but it does not mean that there is only one bus or one type of bus.

The communication interface is configured to perform communication between the electronic device and other devices.

The memory may include a random access memory (RAM), and may also include a non-volatile memory (NVM) such as at least one disk storage. Optionally, the memory may also be at least one storage apparatus located away from the processor.

The processor may be a general-purpose processor, including a central processing unit (CPU) or a network processor (NP), or may be a digital signal processor (DSP), an application-specific integrated circuit (ASIC), a field-programmable gate array (FPGA) or another programmable logic device, a discrete gate or transistor logic device, or a discrete hardware component.

For the implementation and beneficial effects of problem solution of each component of the electronic device in the above embodiment, refer to steps in the embodiment shown in FIG. 3. Therefore, the specific working process and beneficial effects of the electronic device provided by the embodiment of the present invention are not repeated herein.

Another embodiment of the present invention further provides a computer-readable storage medium, storing instructions. The instructions, when executed on a computer, causes the computer to execute the data processing method in any one of the foregoing embodiments.

Another embodiment of the present invention further provides a computer program product including instructions. The computer program product, when executed on a computer, causes the computer to execute the data processing method in any one of the foregoing embodiments.

A person skilled in the art should understand that the embodiments of the present application may be provided as methods, systems, or computer program products. Therefore, the embodiments of the present application may take the form of a hardware only embodiment, a software only embodiment, or an embodiment with both software and hardware. Moreover, the embodiments of the present application may use a form of a computer program product that is implemented on one or more computer-usable storage media (including but are not limited to a magnetic disk memory, a CD-ROM, an optical memory, and the like) that include computer-usable program code.

The embodiments of the present application are described with reference to the flowcharts and/or block diagrams of the methods, devices (systems), and computer program products according to the embodiments of the present application. It should be understood that computer program instructions may be used to implement each process and/or each block in the flowcharts and/or the block diagrams and a combination of a process and/or a block in the flowcharts and/or the block diagrams. These computer program instructions may be provided to a processor of a general-purpose computer, a dedicated computer, an embedded processor, or another programmable data processing device to produce a machine, so that instructions executed by a processor of a computer or another programmable data processing device produce an apparatus for implementing a function specified in one or more processes of the flowchart and/or one or more blocks of the block diagram.

These computer program instructions may also be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operation steps are performed on the computer or the another programmable device to produce computer-implemented processing, thereby providing instructions executed on the computer or the another programmable device to implement the function specified in one or more processes of the flowchart and/or one or more blocks of the block diagram.

Although preferred embodiments of the present application have been described, those skilled in the art may make additional changes and modifications to these embodiments once they learn the basic inventive concept. Therefore, the appended claims are intended to be interpreted as including the preferred embodiments and all changes and modifications that fall within the scope of the embodiments of the present application.

Obviously, a person skilled in the art can make various modifications and variations to the embodiments of the present application without departing from the spirit and scope of the present application. In this way, the embodiments of the present application are intended to include these modifications and variations of the embodiments of the present application provided that they fall within the scope of the claims of the embodiments of the present application and their equivalent technologies.

1. A data processing method, applied to ocean circulation model scenarios, comprising:
dividing geographic regions of the earth in a longitudinal direction, a latitudinal direction, and a vertical direction according to a preset spatial resolution, to obtain a three-dimensional grid structure corresponding to the earth space and grid information of corresponding structures, wherein the grid information comprises geographic regions of grids and regional data in the geographic regions;
dividing, according to a number of configured computing cores, the grids in the grid structure on grid planes corresponding to the longitudinal direction and the latitudinal direction in the grid structure, to obtain divided grid sub-structures corresponding to each computing core and regional data corresponding to corresponding structures;
for each computing core, dividing grids in the grid sub-structures in a first direction or the vertical direction based on a preset division policy, to obtain divided secondary grid sub-structures and regional data corresponding to corresponding structures, and allocating regional data corresponding to the secondary grid sub-structures to a primary computing unit of the computing core, wherein the first direction is the latitudinal direction or the vertical direction, and the secondary grid sub-structures comprise secondary grid sub-structures corresponding to the primary computing unit and secondary grid sub-structures corresponding to at least one computing subunit of the computing core; and
controlling, based on a preset allocation policy, the primary computing unit to allocate regional data corresponding to smaller secondary grid sub-structures to the at least one computing subunit, for each computing subunit, controlling the primary computing unit of the computing core to divide grids in the smaller secondary grid sub-structures in a third direction according to a number of target processing units in the computing subunit, to obtain to-be-processed grid structure corresponding to each target processing unit and regional data corresponding to corresponding structures, and allocating regional data corresponding to the to-be-processed grid structure to the target processing unit, so that the target processing unit can compute the regional data corresponding to the to-be-processed grid structure, so that the primary computing unit and the at least one computing subunit compute service data in the allocated regional data based on a service requirement, wherein the smaller secondary grid sub-structures are obtained by the primary computing unit by dividing grids in the secondary grid sub-structures corresponding to the at least one computing subunit on grid planes corresponding to a second direction and the vertical direction, and the second direction is the latitudinal direction or the longitudinal direction.

2. The method according to claim 1,
wherein the target processing unit is a processing unit that corresponds to a data type of the regional data and that has a vectorized instruction set function.

3. The method according to claim 1, wherein the primary computing unit of the computing core performs data communication with a primary computing unit of another computing core other than the computing core by using a configured information passing interface, and the method further comprises:
transmitting regional data of target grids transmitted by the primary computing unit of the another computing core to the primary computing unit of the computing core, wherein the target grids are grids that have overlapped geographic regions with grids corresponding to the regional data allocated to the computing core; and
the allocating regional data corresponding to the secondary grid sub-structures to a primary computing unit of the computing core comprises:
allocating the regional data of the secondary grid sub-structures and the regional data of the target grids transmitted by the primary computing unit of the another computing core to the primary computing unit of the computing core.

4. The method according to claim 1, wherein the dividing, according to a number of configured computing cores, the grids in the grid structure on grid planes corresponding to the longitudinal direction and the latitudinal direction in the grid structure, to obtain divided grid sub-structures corresponding to each computing core and regional data corresponding to corresponding structures comprises:
determining to-be-computed grids in the grid structure based on a service computing requirement;
equally dividing, according to the number of configured computing cores, to-be-computed grids in the grid structure on grid planes corresponding to the longitudinal direction and the latitudinal direction in the grid structure, to obtain a to-be-computed grid set corresponding to each computing core;
randomly dividing not-to-be-computed grids in the grid structure on the grid planes corresponding to the longitudinal direction and the latitudinal direction in the grid structure, to obtain a grid set corresponding to the not-to-be-computed grids; and
based on the to-be-computed grid set corresponding to each computing core and the grid set corresponding to the not-to-be-computed grids, determining divided grid sub-structures corresponding to each computing core and regional data of corresponding structures.

5. The method according to claim 4, wherein the grid information further comprises a region type of a geographic region of the grids, and the region type comprises an ocean type; and
if the service computing requirement is a computing requirement of a target variable in an ocean circulation model, the determining to-be-computed grids in the grid structure based on a service computing requirement comprises:
obtaining a region type corresponding to each grid in the grid structure; and
determining a grid whose region type is the ocean type as a to-be-computed grid.

6. The method according to claim 1, wherein the primary computing unit and the at least one computing subunit perform data communication with each other in a direct memory access manner.

7. The method according to claim 1, wherein the controlling, based on a preset allocation policy, the primary computing unit to allocate regional data corresponding to smaller secondary grid sub-structures to the at least one computing subunit comprises:
based on a preset two-dimensional division policy in the second direction and the vertical direction, controlling the primary computing unit to divide grids in the secondary grid sub-structures corresponding to the at least one computing subunit on the grid planes corresponding to the second direction and the vertical direction, to obtain the smaller secondary grid sub-structures and regional data corresponding to corresponding structures, so that the primary computing unit allocates regional data corresponding to the divided smaller secondary grid sub-structures to the at least one computing subunit.

8. (canceled)

9. An electronic device, comprising a processor, a communication interface, a memory, and a communication bus, wherein the processor, the communication interface, and the memory communicate with each other through the communication bus; wherein
the memory is configured to store a computer program; and
the processor is configured to execute the program stored in the memory, to perform steps of a data processing method comprising:
dividing geographic regions of the earth in a longitudinal direction, a latitudinal direction, and a vertical direction according to a preset spatial resolution, to obtain a three-dimensional grid structure corresponding to the earth space and grid information of corresponding structures, wherein the grid information comprises geographic regions of grids and regional data in the geographic regions;
dividing, according to a number of configured computing cores, the grids in the grid structure on grid planes corresponding to the longitudinal direction and the latitudinal direction in the grid structure, to obtain divided grid sub-structures corresponding to each computing core and regional data corresponding to corresponding structures;
for each computing core, dividing grids in the grid sub-structures in a first direction or the vertical direction based on a preset division policy, to obtain divided secondary grid sub-structures and regional data corresponding to corresponding structures, and allocating regional data corresponding to the secondary grid sub-structures to a primary computing unit of the computing core, wherein the first direction is the latitudinal direction or the vertical direction, and the secondary grid sub-structures comprise secondary grid sub-structures corresponding to the primary computing unit and secondary grid sub-structures corresponding to at least one computing subunit of the computing core; and
controlling, based on a preset allocation policy, the primary computing unit to allocate regional data corresponding to smaller secondary grid sub-structures to the at least one computing subunit, for each computing subunit, controlling the primary computing unit of the computing core to divide grids in the smaller secondary grid sub-structures in a third direction according to a number of target processing units in the computing subunit, to obtain to-be-processed grid structure corresponding to each target processing unit and regional data corresponding to corresponding structures, and allocating regional data corresponding to the to-be-processed grid structure to the target processing unit, so that the target processing unit can compute the regional data corresponding to the to-be-processed grid structure, so that the primary computing unit and the at least one computing subunit compute service data in the allocated regional data based on a service requirement, wherein the smaller secondary grid sub-structures are obtained by the primary computing unit by dividing grids in the secondary grid sub-structures corresponding to the at least one computing subunit on grid planes corresponding to the second direction and the vertical direction, and the second direction is the latitudinal direction or the longitudinal direction.
